(19) United States
(12) Patent Application Publication
(10) Pub. No.: US 2024/0112014 A1
(43) Pub. Date: Apr. 4, 2024

(54) METHODS AND SYSTEMS FOR AUTOMATED CREATION OF ANNOTATED DATA AND TRAINING OF A MACHINE LEARNING MODEL THEREFROM

(71) Applicant: Robert Bosch GmbH, Stuttgart (DE)

(72) Inventors: Yuheng Wang, Centereach, NY (US); Haibo Ding, Fremont, CA (US); Bingqing Wang, San Jose, CA (US); Zhe Feng, Mountain View, CA (US)

(21) Appl. No.: 17/952,577

(22) Filed: Sep. 26, 2022

(51) Int. Cl. G06N 3/08

(52) U.S. Cl. CPC G06N 3/08

(57) ABSTRACT

The systems and methods described herein are directed to a Co-Augmentation framework that may learn new rules and labels simultaneously from unlabeled data with a small set of seed rules and a few manually labeled training data. The augmented rules and labels are further used to train supervised neural network models. Specifically, the systems and methods described herein include two major components: a rule augmenter, and a label augmenter. The rule augmenter is directed to learning new rules, which can be used to obtain weak labels from unlabeled data. The label augmenter is directed to learning new labels from unlabeled data. The Co-Augmentation framework is an iterative learning process which generates and refines a high precision set. At each iteration, both the rule augmenter and label augmenter will contribute new and more accurate labels to the high precision set, which is in turn used to train both the rule augmenter and label augmenter.

### TECHNICAL FIELD

The present disclosure relates to the creation and use of labeled test data, and in particular to systems and methods for providing an automated process of creating labeled test data and training a machine learning model.

### BACKGROUND

Training accurate machine learning models require large amounts of annotated data. The more training data that is available for training, the more effective the training becomes. For larger models utilizing deep learning, even more, labeled data is required to successfully train the model. Unfortunately, the obvious solution of simply creating more annotated data as training datasets is not scalable. Human review of data and human annotation of that data is required to create additional training data. For areas where machine learning is common, large datasets may already exist.

However, for specific use cases where machine learning has not been applied, annotated data to use as training data is not available. There is a need for a low-cost, scalable solution for creating annotated data to use as training datasets. The creation of datasets is critical for the introduction of machine learning solutions where extensive machine learning training is not available.

### SUMMARY

The systems and methods described herein provide for automated creation of training data and training of a machine learning model therefrom.

Another aspect of the disclosed embodiments includes a method for training a machine learning model using augmented training data. The method includes receiving a plurality of unlabeled training data, at least one seed labeling rule, and at least one seed label and training a named entity recognizer model using the unlabeled training data and the at least one seed labeling rule. The method also includes generating, by the named entity recognizer model, a first label for each of the unlabeled training data and generating first labeled training data based on an identified one of the first labels having a score exceeding a first range and first unlabeled training data of the unlabeled training data associated with the identified first label. The method also includes training a meta-learning model using the unlabeled training data and at least one seed label, generating, by the meta-learning model, a second label for each of the unlabeled training data, and generating second labeled training data based on an identified one of the second labels having a score exceeding a first range and second unlabeled training data of the unlabeled training data associated with the identified second label. The method also includes training the named entity recognizer model using the first labeled training data and the second labeled training data.

Another aspect of the disclosed embodiments includes a system for training a machine learning model using augmented training data. The system includes a processor and a memory. The memory includes instructions that, when executed by the processor, cause the processor to: receive a plurality of unlabeled training data, at least one seed labeling rule, and at least one seed label; train a named entity recognizer model using the unlabeled training data and the at least one seed labeling rule; generate, by the named entity recognizer model, a first label for each of the unlabeled training data; generate first labeled training data based on an identified one of the first labels having a score exceeding a first range and first unlabeled training data of the unlabeled training data associated with the identified first label; train a meta-learning model using the unlabeled training data and at least one seed label; generate, by the meta-learning model, a second label for each of the unlabeled training data; generate second labeled training data based on an identified one of the second labels having a score exceeding a first range and second unlabeled training data of the unlabeled training data associated with the identified second label; and train the named entity recognizer model using the first labeled training data and the second labeled training data.

Another aspect of the disclosed embodiments includes an apparatus for generating data augmentation labeling rules. The apparatus includes a processor and a memory. The memory includes instructions that, when executed by the processor, cause the processor to: receive a plurality of unlabeled training data, at least one seed labeling rule, and at least one seed label; train a named entity recognizer model using the unlabeled training data and the at least one seed labeling rule; generate, by the named entity recognizer model, a first label for each of the unlabeled training data; generate first labeled training data based on an identified one of the first labels having a score exceeding a first range and first unlabeled training data of the unlabeled training data associated with the identified first label; train a meta-learning model using the unlabeled training data and at least one seed label; generate, by the meta-learning model, a second label for each of the unlabeled training data; generate second labeled training data based on an identified one of the second labels having a score exceeding a first range and second unlabeled training data of the unlabeled training data associated with the identified second label; train the named entity recognizer model using the first labeled training data and the second labeled training data; and generate at least one seed labeling rule based on an identified first labeling rule, wherein the first labeling rule is generated based on the first labeled training data using one or more rule templates that include at least one simple rule with at least one predicate.

### BRIEF DESCRIPTION OF THE DRAWINGS

FIG. 1 generally illustrates a system for training a neural network, according to the principles of the present disclosure.

FIG. 2 generally illustrates a computer-implemented method for training and utilizing a neural network, according to the principles of the present disclosure.

FIG. 3 is a flow chart generally illustrating the process for simultaneous dual training data augmentation according to the principles of the present disclosure.

FIG. 4 is a flow chart generally illustrating an alternative machine learning model training method according to the principles of the present disclosure.

FIGS. 5A and 5B are flow charts generally illustrating an alternative machine learning model training method and use according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As described, training accurate machine learning models requires a large amount of annotated data. The more training data that is available for training, the more effective the training becomes. For larger models utilizing deep learning, even more, labeled data is required to successfully train the model. Unfortunately, the obvious solution of simply creating more annotated data as training datasets is not scalable. Human review of data and human annotation of that data is required to create additional training data. For areas where machine learning is common, large datasets may already exist.

However, for specific use cases where machine learning has not been applied, annotated data to use as training data is not available. There is a need for a low-cost, scalable solution for creating annotated data to use as training datasets. The creation of datasets is critical for the introduction of machine learning solutions where extensive machine learning training is not available.

The systems and methods described herein may show an effective approach to address this low-resource problem is weakly supervised learning, which collects weak labels for training neural models. The systems and methods described herein show that with minimum human effort (e.g., a number of seed rules only) the weak supervision system can automatically learn more rules from unlabeled data, which can be further used to collect a greater quantity of weak labels and more accurate weak labels. The methods and systems described herein have achieved relatively good performance with only a handful set of seed rules on domain-specific tasks.

The methods and systems described herein comprise two major components: a rule augmenter and a label augmenter. The rule augmenter attempts to learn new labeling rules from a small set of seed rules, which will be further used to generate weak labels. The label augmenter may augment labels directly. At each learning iteration, both components will contribute the most accurate weak labels to a high-precision set, which will be in turn used to train machine learning models of these two components.

The systems and methods described herein include a rule augmenter which includes a rule applier which applies rules to unlabeled data to obtain weak labels. The rule augmenter also includes a label selector which selects high precision labels from weak labels and puts them into the high precision set. The rule augmenter also includes a Neural named entity recognizer model which trains the model on the high precision data and makes predictions on the whole data to extract more candidate named entities. The rule augmenter also includes a rule selector which scores and selects accurate labeling rules from candidate rules using the neural named entity recognizer model's prediction.

The systems and methods described herein include a label augmenter. The label augmenter includes a meta-learning model which is trained on the high precision data and which applies it to unlabeled data to obtain weak labels. The methods and systems described herein include a label selector which selects high precision labels from weak labels which are added to the high precision set.

The systems and methods described herein are intended to be executed as part of an iterative process. At each learning iteration, both rule augmenter and label augmenter augment labeling knowledge simultaneously based on existing seed rules and manual labels. In some embodiments, the systems and methods described herein may configure the rule augmenter to first learn new labeling rules based on existing seed rules and then generate accurate weak labels using the learned labeling rules. Simultaneously, the label augmenter is configured to directly train a meta-learning model using the input labels and estimates the labels of unlabeled data. The systems and methods described herein are configured to select highly accurate labels and add them to the high-precision set for the next learning iteration. The systems and methods described herein may use ProtoBERT as the meta-learning model in the label augmenter.

The systems and methods described herein include a rule augmenter configured to learn labeling rules, and generate weak labels based on the learned labeling rules. The systems and methods described herein is configured to learn new rules and generate weak labels with the rule augmenter. The systems and methods described herein are configured to apply seed rules to unlabeled data (Rule Applier) and obtain weak labels (Label Selector). The systems and methods described herein are configured to train a neural named entity recognizer model using the weak labels (generated by the neural named entity recognizer model), and learn new labeling rules (by the Rule Selector) using the predictions of unlabeled data and using the trained named entity recognizer model.

When the methods and systems described herein are given the unlabeled candidate entity spans and a set of labeling rules, the rule applier applies all the labeling rules on unlabeled spans to obtain weakly labeled data and adopts a voting method to deal with conflicting rules. For example, when a span is matched by three different rules, among which two give the label as “Organization” and one gives the label as “Location,” the rule-based labeler will take the majority as the label of that span, in this instance “Organization.”

The systems and methods described herein include newly labeled spans by the labeling rules which can be noisy (i.e., some of the weakly generated labels can be incorrect). The systems and methods described herein may reduce label noise by using the following process to select accurate labels. The systems and methods described herein may compute the span embedding (the embedding of an entity span) as a way of embedding its tokens. Based on that computation, the systems and methods described herein may compute both the local score and the global score for a candidate span.

The systems and methods described herein may include a local score. Given the embedding es of a weakly labeled span s and all the embeddings of the examples from the high precision label set with label Dhigh, the pairwise cosine similarity between and each embedding in EC may be computed. Then, the maximum of the similarity values is used for the local score for es.

$${score}_{s}^{lcl} = {min}_{{e}_{c} ∈ {E}^{c}} ( cos ( {e}_{s} , {e}_{c} ) )$$

The systems and methods described herein may include a global score. A small set E^{C} is sampled from D_{high} with label c, and then the prototypical embedding of E^{C} is computed. The global score is computed as:

$${score}_{c}^{glb} = \frac{1}{N} {\sum }_{1 \leq j \leq N} cos ( {e}_{s} , {z}_{E}^{c} )$$

The systems and methods described herein may compute the final score of each span s as a geometric mean of local scores and global scores and select them with a dynamic threshold.

The systems and methods described herein may include a dynamic threshold. The span selection standard is not fixed. As the high precision label set keeps being maintained, the threshold for selecting spans also changes over iterations. The systems and methods described herein may hold out one entity span in and compute the score of the entity span with respect to the rest of the examples in Dhigh. This procedure is repeated for T times and ends up with the minimum value as the threshold. For class c, it is calculated as:

$$threshold = τ {min}_{k \leq T , {e}_{k} ∈ {H}_{i}} {score}_{c} ( {e}_{k} ) .$$

The systems and methods described herein may include span representation. Given a sentence x=[w₁, w₂, . . . , wₙ] of tokens, a span sᵢ=[w_{bi}, w_{bi+1}, . . . , wₑᵢ], where bi and e; are the start and end indices respectively. Two parts of embeddings are concatenated as a span representation zᵢ: (1) a content representation z^{c}ᵢ using the weighted average embeddings of the tokens in the span, and (2) a boundary representation z^{u}ᵢ containing both the position embeddings at bᵢ and eᵢ. Specifically:

c₁,c₂, . . . ,cₙ=TokenRepr(w₁,w₂, . . . ,wₙ)

u₁,u_{z}, . . . ,uₙ=BiLSTM(c₁,c₂, . . . ,cₙ)

zᵢ^{u}=[u_{b}_{ᵢ};uₑ_{ᵢ}],zᵢ=[zᵢ^{c};zᵢ^{u}]

The systems and methods described herein may include a span prediction which is a multilayer perceptron (MLP) that predicts labels for all spans up to a fixed length of 1 words, using span representation, oᵢ=softmax(MLP^{span}(zᵢ)), where oᵢ is a predicted result.

The systems and methods described herein include a rule-based selector that has different types of rule templates for automatically generating candidate rules. All the rule templates are simple rules with only one predicate, including SurfaceForm (e.g., ORG←Bosch LLC), Prefix (e.g., Chemical←levo*), Suffix (e.g., Chemical←pine*), PreNGram (e.g., LOC←located_in_*), PostNGram (e.g., LOC←*_'s_capital), POSTag (e.g., LOC←PROPN_PROPN), and PreDependency (e.g., LOC←head of obl_in). Candidate rules are automatically generated by combining simple rules with a conjunction. For example, in the sentence “Mary was hired by Bosch LLC yesterday”, the organization name “Bosch LLC” is extracted by the conjunction candidate rule ORG←hired_by_*\hat{ }PROPN_PROPN, which consists of two simple rules ORG←hired_by_* and ORG←PROPN_PROPN.

The systems and rules described here may learn new labeling rules by estimating the labels of unlabeled data using the trained named entity recognizer model described above and computing the confidence score for each candidate labeling rule. Where F_{c} is the number of spans extracted by rule r_{c} and N_{c} is the total number of spans extracted by rule rᵢ. Specifically, we use the RlogF method to score a candidate rule r_{c} for class c:

$$F ( {r}_{c} ) = \frac{{F}_{c}}{{N}_{c}} * {log}_{2} ( {F}_{c} )$$

The systems and methods described herein consider both the precision and recall of rules because the

$$\frac{rc}{Nc}$$

is the precision score of the rule and log₂(r_{c}) represents the rule's ability to cover more spans. Then, we rank the rules by F(r) and select top K rules as new labeling rules for each class per iteration, where K increases per m iterations.

The systems and methods described herein include a label augmenter which may expand existing labels based on the intrinsic property of instances. In the systems and methods described herein, the label augmenter consists of two components, a meta-learning model and a label selector.

The systems and methods described herein may implement the meta-learning model using a ProtoBERT model, which is based on prototypical neural networks. ProtoBERT is a meta-learning model which may be trained by predicting labels of query set Q with the information of support set S, where S and Q are randomly sampled from training data and S ∩Q=Ø. The ProtoBERT model is also based on a prototypical neural network with a BERT encoder as its backbone. The systems and methods described herein may compute a prototype z for each entity type by computing the average of the embeddings of the tokens that share the same entity type.

In the training phrase, we first sample support and query sets. Then for the c-th class label, its prototype is computed as below based on the support set Sc:

$${z}_{c} = \frac{1}{\vert {S}_{c} \vert} {\sum }_{x ∈ {s}_{c}} {f}_{θ} ( x )$$

The systems and methods described herein may estimate the predictions of each token based on the token's distances to all class prototypes.

The systems and methods described herein include a ProtoBERT labeling phase, where the whole label set is used to compute for each class label z_{c}. The systems and methods described herein may predict the labels of unlabeled data based using these prototypes. The label on each token is the label of the nearest prototype to x. That is, for a high precision label set D_{high} with C types and a query x, the prediction process is given as:

$${c}^{*} = arg {min}_{c ∈ C} {d}_{c} ( x ) ,$$

$${d}_{c} ( x ) = d ( {f}_{θ} ( x ) , {z}_{c} ) .$$

The systems and methods described herein may, for each learning iteration, select highly accurate labels based on the estimation of the above-trained meta-learning model. Since the meta-learning model is trained with only a small amount of labels, the accuracy of selected labels may be critical to maintaining the precision of the high-precision set. The systems and methods described herein may estimate the distance scores of all unlabeled instances to class prototypes. The systems and methods described herein may design two methods to select high-precision labels:

In some embodiments, the systems and methods included herein may include a top-percent which uses a parameter τ ∈ (0,1) to control the portion of how many labels are reliable enough to add them to the high precision set. For example, in each iteration, the ProtoBERT model predicts 100 new labels. If τ=10%, the label selector will select the top 100*10%=10 labels ranked based on the distance scores to the high precision label set.

In some embodiments, the systems and methods included herein may include a top-k process which selects the top k labels for addition to the high precision label set, based on their prediction scores.

The systems and methods described herein describe the procedure of the training algorithm of our CoAug framework. In order to obtain the transferability to unseen labels, we sample different few-shot data from different class sets (random C classes from total N classes) as the initial few-shot resource.

Algorithm 1 The CoAug Algorithm

Input:

| | |
|---|---|
| 1. | Labeled data D_{L} with C classes |
| 2. | Unlabeled data D_{U} |
| 3. | Seed rules R_{C} for each of the C classes |

Initialization:

| | |
|---|---|
| 1. | Randomly init ProtoBERT |

For 1 to max_sampling_iter do

| 1. | Sample N classes from labeled data D_{L} | |
|---|---|---|
| 2. | Sample a subset of labeled data D_{N} for each of the N classes | |
| 3. | Initialize high precision label set D_{High} = D_{N} | |
| 4. | Initialize labeling rule set R = R_{N} | |
| 5. | For 1 to max_cotrain_iter do | |
| | a. | Label unlabeled data D_{U} with labeling rule set R |
| | b. | Select high precision labels Dᵣᵤₗₑ from rule labeled data obtained in 5.a |
| | c. | Train ProtoBERT with high precision label set D_{High} |

| | |
|---|---|
| i) | For 1 to max_meta_iter do |
| | • Sample one support set S, and one query set Q from D_{High} |
| | • Compute loss and update ProtoBERT |

| | |
|---|---|
| d. | Label unlabeled data D_{U} with trained ProtoBERT |

| | |
|---|---|
| i) | Compute prototypes using D_{High} |
| ii) | Predict on D_{U} using prototypes |

| | |
|---|---|
| e. | Select high precision labels Dₚᵣₒₜₒ from ProtoBERT labeled data obtained in 5.d |
| f. | Update high precision label set D_{High} = D_{High} ∪ Dᵣᵤₗₑ ∪ Dₚᵣₒₜₒ |
| g. | Randomly initialize span-based NER model |
| h. | Train and validate span-based NER model using D_{High} |
| i. | Predict on D_{N} ∪ D_{U} to get soft labels L_{weak} |
| j. | Score and select rules using L_{weak} to update labeling rule set R |

By augmenting data from two complementary sources using the CoAug algorithm, the low-resource problems can be alleviated and the transferability to new domains can be more robust.

The systems and methods described herein may include a processor and memory. The systems and methods described herein configuring the memory with instructions that, when executed by the processor, cause the processor to receive a plurality of unlabeled training data, at least one seed labeling rule, and at least one seed label. The systems and methods described herein may train a named entity recognizer model using the unlabeled training data and at least one seed labeling rule. The systems and methods described herein may generate, by the named entity recognizer model, a first label for each of the unlabeled training data. The systems and methods described herein may determine a confidence score of each respective first label. The systems and methods described herein may identify at least one respective first label having a value that is greater than a first range. The systems and methods described herein may generate a first labeled training data based on the identified at least one respective first label and unlabeled training data associated with the at least one respective first label. The systems and methods described herein may train a meta-learning model using the unlabeled training data and at least one seed label. The systems and methods described herein may generate, by the meta-learning model, a second label for each of the unlabeled training data. The systems and methods described herein may determine a confidence score of each respective second label. The systems and methods described herein may identify at least one respective second label having a value that is greater than a second range. The systems and methods described herein may generate a second labeled training data based on the identified respective second label and unlabeled training data associated with the at least one respective second label. The systems and methods described herein may train the named entity recognizer model using the first labeled training data and the second labeled training data. The systems and methods described herein may generate, by the named entity recognizer model, a first labeling rule for each of the first training data and second training data. The systems and methods described herein may determine a confidence score of each respective first labeling rule. The systems and methods described herein may identify at least one respective first labeling rule having a value that is greater than a third range. The systems and methods described herein may generate at least one seed labeling rule based on the identified respective first labeling rule.

The systems and methods described herein may generate the first labels by the named entity recognizer model and generate the second labels by the meta-learning model in parallel.

The systems and methods described herein may be configured to resolve conflicting labels based on voting, wherein a label losing the vote is modified in favor of a label that won the vote.

The systems and methods described herein where the first range, second range, and third range corresponding to a respective percentage range.

The systems and methods described herein where the first range, second range, and third range correspond to one or more respective predetermined values that indicate a limit.

The systems and methods described herein where the labeling rules are generated using one or more rule templates, the one or more rule templates including at least one respective simple rule with at least one respective predicate.

The systems and methods described herein may further comprise the meta-learning model being a ProtoBERT model.

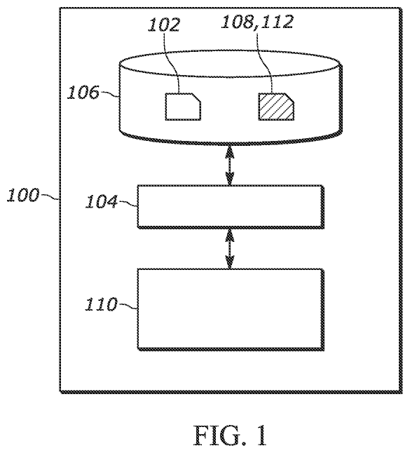

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

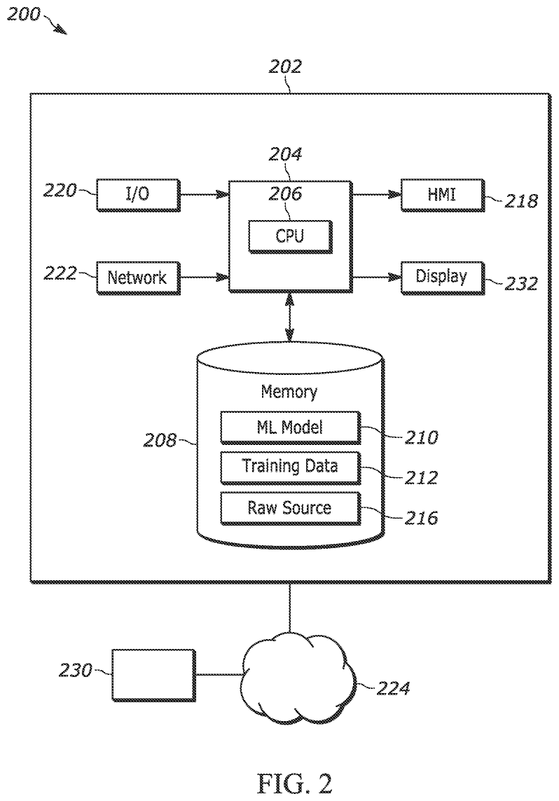

FIG. 2 depicts a data annotation/augmentation system 200 to implement a system for annotating and/or augment data. The data annotation system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, and raw or partially processed sensor data (e.g., radar map of objects). In some embodiments, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., pedestrian). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In the example, the machine-learning algorithm 210 may process raw source data 216 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present

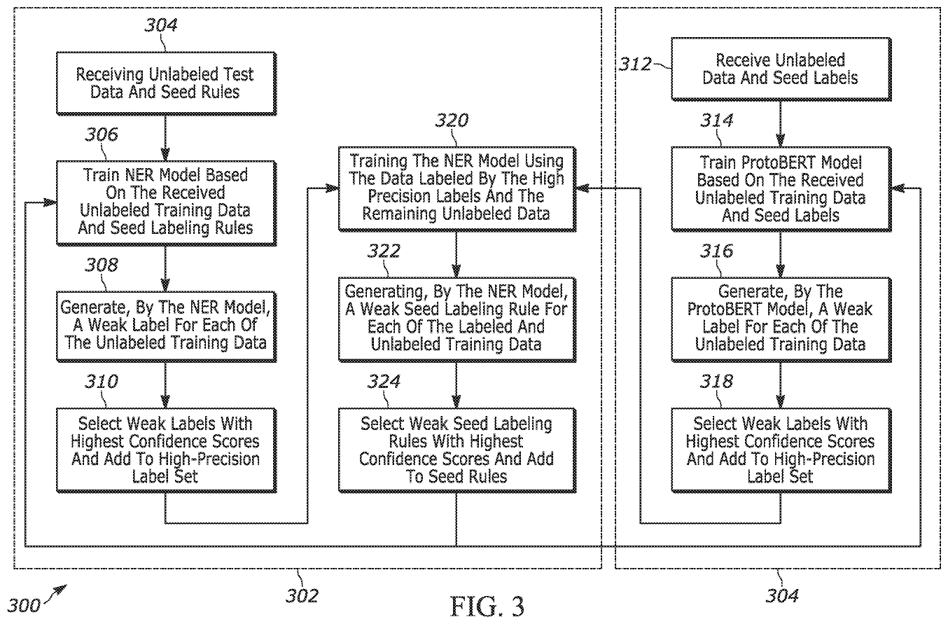

FIG. 3 is a block diagram illustrating a high-level overview of the training process 300. The training process 300 may be subdivided into rule augmenter 302 and label augmenter 304. At 304, the process 300 receives unlabeled data and seed rules. The seed rules may have been generated by a human or a machine learning model. The process 300 receives a small set of labels and seed rules, as well as large set of unlabeled data as input.

At 306, the process 300 trains a neural named entity recognizer model based on the seed labeling rules and the unlabeled data. At 308, the process 300 generates, by the neural named entity recognizer model, weak labels for each of the unlabeled training data. The process 300 first learns new labeling rules based on existing seed rules and then generates weak labels using the labeling rules learned by neural named entity recognizer model. The process 300, ranks the weak labels generated by the neural named entity recognizer model based on the confidence score of each label. At 310, the process 300 determines which weak labels are above a predetermined range are selected and added to the high precision label set. The range may be selected based on the top percentage of top ranked weak labels or based on a predetermined number of top ranked weak labels.

At 312, the process 300, receives the unlabeled data and seed labels. The seed labels being created either by a human or a trained machine learning model. At 314, the process 300 trains the ProtoBERT model based on the received unlabeled training data and seed labels. The ProtoBERT model is a meta-learning model which is trained by predicting labels for the unlabeled data with the information based on the seed rules and random samples from the unlabeled training data. At 316, the process 300 generates, by the ProtoBERT model, a weak label for each of the unlabeled training data. Alternatively, the ProtoBERT model may generate weak labels for samples of the unlabeled training data. At 318, the process 300 determines which weak labels are above a predetermined range are selected and added to the high precision label set. The range may be selected based on the top percentage of top ranked weak labels or based on a predetermined number of top ranked weak labels.

At 320, the process receives the high precision dataset which is used to further train the neural named entity recognizer model and the unlabeled training data. At 322, the process 300 generates, by the neural named entity recognizer model, weak seed labeling rules based on the unlabeled training data and/or the labeled training data. At 324, the process 300 selects weak seed labeling rules based on a confidence score of each weak seed labeling rule. Weak seed labels which are above a predetermined range are selected and added to the seed rule set. The range may be selected based on the top percentage of top ranked weak seed labels or based on a predetermined number of top ranked weak seed labels. The process is iterative and with each iteration, the models are further trained to become more accurate and the label in the high precision label set continues to increase in accuracy.

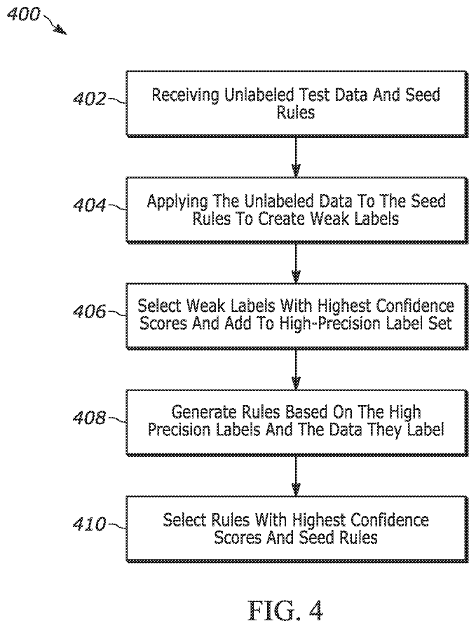

FIG. 4 is a block diagram illustrating a high level overview of the process 400 of rule augmenter 302. At 402, the process 400 receives unlabeled test data and seed rules. The seed rules being generated by a human or a pretrained machine learning model. At 404, the process 400 applies the unlabeled test data to the seed rules to create weak labels. Each unlabeled test data may have multiple labels or no labels at all.

At 406, the process 400 ranks the weak labels based on a confidence score. The process 300 determines which weak labels are above a predetermined range are selected and added to the high precision label set. The range may be selected based on the top percentage of top ranked weak labels or based on a predetermined number of top ranked weak labels. At 408, the process generates weak seed rules based on the high precision set and the labeled training data. At 410, process 400 selects rules with the highest confidence score and adds them to the seed rule set.

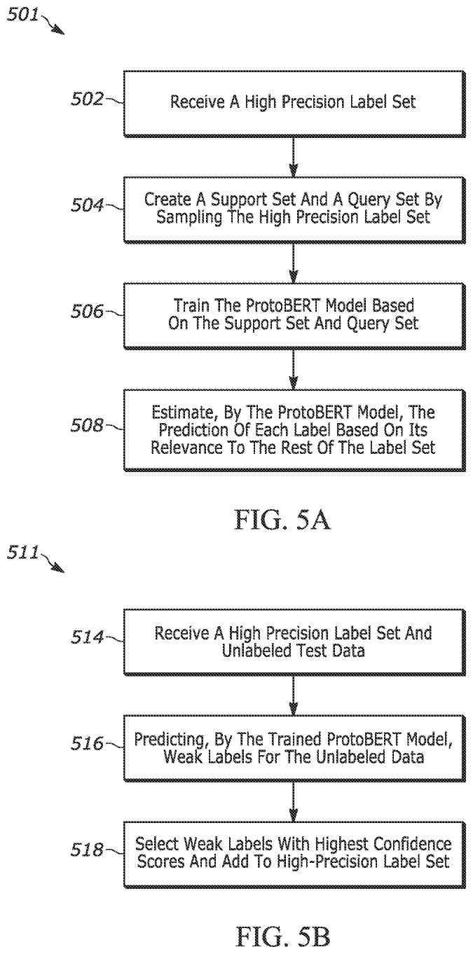

FIG. 5A is a block diagram illustrating a high level overview process 501 where the ProtoBert model is initially trained. At 502, the process 501 receives a high precision label set associated with the training data. At 504, the process 501 creates a support set and a query set by sampling the high precision label set and its associated training data. At 506, the process 501 trains the ProtoBERT model based on the support set and query set. At 508, the process 501 estimates, by the ProtoBERT model, the prediction of each label based on its relevance to the rest of the label set.

FIG. 5B is a block diagram illustrating a high level overview of process 511 where the ProtoBert model is used to generate labels after its initial training. At 514, the process 511 receives a high precision label set and its associated unlabeled training data. At 516, the process 511 predicts, by the ProtoBERT model, weak labels for the unlabeled data. At 518, the process 511 selects weak labels with the highest confidence scores and adds them to the high precision label set. The selection process determines which weak labels to select based on which weak labels are above a predetermined range are selected and added to the high precision label set. The range may be selected based on the top percentage of top ranked weak labels or based on a predetermined number of top ranked weak labels.

In some embodiments, the method for automated dataset augmentation and machine learning model training includes receiving a plurality of unlabeled training data, at least one seed labeling rule, and at least one seed label; training a named entity recognizer model using the unlabeled training data and at least one seed labeling rule; generating, by the named entity recognizer model, a first label for each of the unlabeled training data; determining a confidence score of each respective first label; identifying at least one respective first label having a value that is greater than a first range; generating a first labeled training data based on the identified at least one respective first label and unlabeled training data associated with the at least one respective first label; training a meta-learning model using the unlabeled training data and at least one seed label; generating, by the meta-learning model, a second label for each of the unlabeled training data; determining a confidence score of each respective second label; identifying at least one respective second label having a value that is greater than a second range; generating a second labeled training data based on the identified respective second label and unlabeled training data associated with the at least one respective second label; training the named entity recognizer model using the first labeled training data and the second labeled training data; generating, by the named entity recognizer model, a first labeling rule for each of the first training data and second training data; determining a confidence score of each respective first labeling rule; identifying at least one respective first labeling rule having a value that is greater than a third range; and generating at least one seed labeling rule based on the identified respective first labeling rule.

In some embodiments, the method further comprises generating the first labels by the named entity recognizer model and generating the second labels by the meta-learning model in parallel.

In some embodiments, the method further comprises conflicting labels which are resolved based on voting, wherein a label losing the vote is modified in favor of a label that won the vote.

In some embodiments, the method further comprises the first range, second range, and third range corresponding to a respective percentage range.

In some embodiments, the method further comprises the first range, second range, and third range corresponding to one or more respective predetermined values that indicate a limit.

In some embodiments, the method further comprises the labeling rules are generated using one or more rule templates, the one or more rule templates including at least one respective simple rule with at least one respective predicate.

In some embodiments, the method further comprises the meta-learning model being a ProtoBERT model.

In some embodiments, a system for automated dataset augmentation and machine learning model training includes a processor and memory. The memory includes instructions that, when executed by the processor, cause the processor to receive a plurality of unlabeled training data, at least one seed labeling rule, and at least one seed label; train a named entity recognizer model using the unlabeled training data and at least one seed labeling rule; generate, by the named entity recognizer model, a first label for each of the unlabeled training data; determine a confidence score of each respective first label; identify at least one respective first label having a value that is greater than a first range; generating a first labeled training data based on the identified at least one respective first label and unlabeled training data associated with the at least one respective first label; train a meta-learning model using the unlabeled training data and at least one seed label; generate, by the meta-learning model, a second label for each of the unlabeled training data; determine a confidence score of each respective second label; identify at least one respective second label having a value that is greater than a second range; generate a second labeled training data based on the identified respective second label and unlabeled training data associated with the at least one respective second label; train the named entity recognizer model using the first labeled training data and the second labeled training data; generate, by the named entity recognizer model, a first labeling rule for each of the first training data and second training data; determine a confidence score of each respective first labeling rule; identify at least one respective first labeling rule having a value that is greater than a third range; and generate at least one seed labeling rule based on the identified respective first labeling rule.

In some embodiments, the system further comprises generating the first labels by the named entity recognizer model and generating the second labels by the meta-learning model in parallel.

In some embodiments, the system further comprises conflicting labels which are resolved based on voting, wherein a label losing the vote is modified in favor of a label that won the vote.

In some embodiments, the system further comprises the first range, second range, and third range corresponding to a respective percentage range.

In some embodiments, the system further comprises the first range, second range, and third range corresponding to one or more respective predetermined values that indicate a limit.

In some embodiments, the system further comprises the labeling rules are generated using one or more rule templates, the one or more rule templates including at least one respective simple rule with at least one respective predicate.

In some embodiments, the system further comprises the meta-learning model being a ProtoBERT model.

In some embodiments, the apparatus includes a processor and memory. The memory includes instructions that, when executed by the processor, cause the processor to receive a plurality of unlabeled training data, at least one seed labeling rule, and at least one seed label; train a named entity recognizer model using the unlabeled training data and at least one seed labeling rule; generate, by the named entity recognizer model, a first label for each of the unlabeled training data; determine a confidence score of each respective first label; identify at least one respective first label having a value that is greater than a first range; generating a first labeled training data based on the identified at least one respective first label and unlabeled training data associated with the at least one respective first label; train a meta-learning model using the unlabeled training data and at least one seed label; generate, by the meta-learning model, a second label for each of the unlabeled training data; determine a confidence score of each respective second label; identify at least one respective second label having a value that is greater than a second range; generate a second labeled training data based on the identified respective second label and unlabeled training data associated with the at least one respective second label; train the named entity recognizer model using the first labeled training data and the second labeled training data; generate, by the named entity recognizer model, a first labeling rule for each of the first training data and second training data; determine a confidence score of each respective first labeling rule; identify at least one respective first labeling rule having a value that is greater than a third range; and generate at least one seed labeling rule based on the identified respective first labeling rule.

In some embodiments, the apparatus further comprises generating the first labels by the named entity recognizer model and generating the second labels by the meta-learning model in parallel.

In some embodiments, the apparatus further comprises conflicting labels which are resolved based on voting, wherein a label losing the vote is modified in favor of a label that won the vote.

In some embodiments, the apparatus further comprises the first range, second range, and third range corresponding to a respective percentage range.

In some embodiments, the apparatus further comprises the first range, second range, and third range corresponding to one or more respective predetermined values that indicate a limit.

In some embodiments, the apparatus further comprises the labeling rules are generated using one or more rule templates, the one or more rule templates including at least one respective simple rule with at least one respective predicate.

In some embodiments, the apparatus further comprises the meta-learning model being a ProtoBERT model.

In some embodiments, a method for training a machine learning model using augmented training data includes receiving a plurality of unlabeled training data, at least one seed labeling rule, and at least one seed label; training a named entity recognizer model using the unlabeled training data and the at least one seed labeling rule; generating, by the named entity recognizer model, a first label for each of the unlabeled training data; generating first labeled training data based on an identified one of the first labels having a score exceeding a first range and first unlabeled training data of the unlabeled training data associated with the identified first label; training a meta-learning model using the unlabeled training data and at least one seed label; generating, by the meta-learning model, a second label for each of the unlabeled training data; generating second labeled training data based on an identified one of the second labels having a score exceeding a first range and second unlabeled training data of the unlabeled training data associated with the identified second label; and training the named entity recognizer model using the first labeled training data and the second labeled training data.

In some embodiments, the method also includes generating the first labels by the named entity recognizer model and generating the second labels by the meta-learning model in parallel. In some embodiments, conflicting labels are resolved based on voting, wherein a label losing the vote is modified in favor of a label that won the vote. In some embodiments, the first range and second range correspond to a respective percentage range. In some embodiments, the first range and second range correspond to one or more respective predetermined values that indicate a limit. In some embodiments, the method also includes: generating, by the named entity recognizer model, a first labeling rule for each of the first labeled training data; determining a score of each first labeling rule; identifying a first labeling rule having a score that is greater than a third range; and generating at least one seed labeling rule based on the identified first labeling rule, wherein the first labeling rule is generated using one or more rule templates that include at least one simple rule with at least one predicate. In some embodiments, the meta-learning model includes a ProtoBERT model.

In some embodiments, a system for training a machine learning model using augmented training data includes a processor and a memory. The memory includes instructions that, when executed by the processor, cause the processor to: receive a plurality of unlabeled training data, at least one seed labeling rule, and at least one seed label; train a named entity recognizer model using the unlabeled training data and the at least one seed labeling rule; generate, by the named entity recognizer model, a first label for each of the unlabeled training data; generate first labeled training data based on an identified one of the first labels having a score exceeding a first range and first unlabeled training data of the unlabeled training data associated with the identified first label; train a meta-learning model using the unlabeled training data and at least one seed label; generate, by the meta-learning model, a second label for each of the unlabeled training data; generate second labeled training data based on an identified one of the second labels having a score exceeding a first range and second unlabeled training data of the unlabeled training data associated with the identified second label; and train the named entity recognizer model using the first labeled training data and the second labeled training data.

In some embodiments, the instructions further cause the processor to generate the first labels by the named entity recognizer model and generate the second labels by the meta-learning model in parallel. In some embodiments, conflicting labels are resolved based on voting, wherein a label losing the vote is modified in favor of a label that won the vote. In some embodiments, the first range and second range correspond to a respective percentage range. In some embodiments, the first range and second range correspond to one or more respective predetermined values that indicate a limit. In some embodiments, the instructions further cause the processor to: generate, by the named entity recognizer model, a first labeling rule for each of the first labeled training data; determine a score of each first labeling rule; identify a first labeling rule having a score that is greater than a third range; and generate at least one seed labeling rule based on the identified first labeling rule, wherein the first labeling rule is generated using one or more rule templates that include at least one simple rule with at least one predicate. In some embodiments, the meta-learning model includes a ProtoBERT model.

In some embodiments, an apparatus for generating data augmentation labeling rules includes a processor and a memory. The memory includes instructions that, when executed by the processor, cause the processor to: receive a plurality of unlabeled training data, at least one seed labeling rule, and at least one seed label; train a named entity recognizer model using the unlabeled training data and the at least one seed labeling rule; generate, by the named entity recognizer model, a first label for each of the unlabeled training data; generate first labeled training data based on an identified one of the first labels having a score exceeding a first range and first unlabeled training data of the unlabeled training data associated with the identified first label; train a meta-learning model using the unlabeled training data and at least one seed label; generate, by the meta-learning model, a second label for each of the unlabeled training data; generate second labeled training data based on an identified one of the second labels having a score exceeding a first range and second unlabeled training data of the unlabeled training data associated with the identified second label; train the named entity recognizer model using the first labeled training data and the second labeled training data; and generate at least one seed labeling rule based on an identified first labeling rule, wherein the first labeling rule is generated based on the first labeled training data using one or more rule templates that include at least one simple rule with at least one predicate.

In some embodiments, the instructions further cause the processor to generate the first labels by the named entity recognizer model and generate the second labels by the meta-learning model in parallel. In some embodiments, conflicting labels are resolved based on voting, wherein a label losing the vote is modified in favor of a label that won the vote. In some embodiments, the first range and second range correspond to a respective percentage range. In some embodiments, the first range and second range correspond to one or more respective predetermined values that indicate a limit. In some embodiments, the meta-learning model includes a ProtoBERT model.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training a machine learning model using augmented training data, the method comprising:
receiving a plurality of unlabeled training data, at least one seed labeling rule, and at least one seed label;
training a named entity recognizer model using the unlabeled training data and the at least one seed labeling rule;
generating, by the named entity recognizer model, a first label for each of the unlabeled training data;
generating first labeled training data based on an identified one of the first labels having a score exceeding a first range and first unlabeled training data of the unlabeled training data associated with the identified first label;
training a meta-learning model using the unlabeled training data and at least one seed label;
generating, by the meta-learning model, a second label for each of the unlabeled training data;
generating second labeled training data based on an identified one of the second labels having a score exceeding a first range and second unlabeled training data of the unlabeled training data associated with the identified second label; and
training the named entity recognizer model using the first labeled training data and the second labeled training data.

2. The method of claim 1, further comprising generating the first labels by the named entity recognizer model and generating the second labels by the meta-learning model in parallel.

3. The method of claim 1, wherein conflicting labels are resolved based on voting, wherein a label losing the vote is modified in favor of a label that won the vote.

4. The method of claim 1, wherein the first range and second range correspond to a respective percentage range.

5. The method of claim 1, wherein the first range and second range correspond to one or more respective predetermined values that indicate a limit.

6. The method of claim 1, further comprising:
generating, by the named entity recognizer model, a first labeling rule for each of the first labeled training data;
determining a score of each first labeling rule;
identifying a first labeling rule having a score that is greater than a third range; and
generating at least one seed labeling rule based on the identified first labeling rule, wherein the first labeling rule is generated using one or more rule templates that include at least one simple rule with at least one predicate.

7. The method of claim 1, wherein the meta-learning model includes a ProtoBERT model.

8. A system for training a machine learning model using augmented training data, the system comprising:
a processor; and
a memory including instructions that, when executed by the processor, cause the processor to:
receive a plurality of unlabeled training data, at least one seed labeling rule, and at least one seed label;
train a named entity recognizer model using the unlabeled training data and the at least one seed labeling rule;
generate, by the named entity recognizer model, a first label for each of the unlabeled training data;
generate first labeled training data based on an identified one of the first labels having a score exceeding a first range and first unlabeled training data of the unlabeled training data associated with the identified first label;
train a meta-learning model using the unlabeled training data and at least one seed label;
generate, by the meta-learning model, a second label for each of the unlabeled training data;
generate second labeled training data based on an identified one of the second labels having a score exceeding a first range and second unlabeled training data of the unlabeled training data associated with the identified second label; and
train the named entity recognizer model using the first labeled training data and the second labeled training data.

9. The system of claim 8, wherein the instructions further cause the processor to generate the first labels by the named entity recognizer model and generate the second labels by the meta-learning model in parallel.

10. The system of claim 8, wherein conflicting labels are resolved based on voting, wherein a label losing the vote is modified in favor of a label that won the vote.

11. The system of claim 8, wherein the first range and second range correspond to a respective percentage range.

12. The system of claim 8, wherein the first range and second range correspond to one or more respective predetermined values that indicate a limit.

13. The system of claim 8, wherein the instructions further cause the processor to:
generate, by the named entity recognizer model, a first labeling rule for each of the first labeled training data;
determine a score of each first labeling rule;
identify a first labeling rule having a score that is greater than a third range; and
generate at least one seed labeling rule based on the identified first labeling rule, wherein the first labeling rule is generated using one or more rule templates that include at least one simple rule with at least one predicate.

14. The system of claim 8, wherein the meta-learning model includes a ProtoBERT model.

15. An apparatus for generating data augmentation labeling rules, the apparatus comprising:
a processor; and
a memory including instructions that, when executed by the processor, cause the processor to:
receive a plurality of unlabeled training data, at least one seed labeling rule, and at least one seed label;
train a named entity recognizer model using the unlabeled training data and the at least one seed labeling rule;
generate, by the named entity recognizer model, a first label for each of the unlabeled training data;
generate first labeled training data based on an identified one of the first labels having a score exceeding a first range and first unlabeled training data of the unlabeled training data associated with the identified first label;
train a meta-learning model using the unlabeled training data and at least one seed label;
generate, by the meta-learning model, a second label for each of the unlabeled training data;
generate second labeled training data based on an identified one of the second labels having a score exceeding a first range and second unlabeled training data of the unlabeled training data associated with the identified second label;
train the named entity recognizer model using the first labeled training data and the second labeled training data; and
generate at least one seed labeling rule based on an identified first labeling rule, wherein the first labeling rule is generated based on the first labeled training data using one or more rule templates that include at least one simple rule with at least one predicate.

16. The apparatus of claim 15, wherein the instructions further cause the processor to generate the first labels by the named entity recognizer model and generate the second labels by the meta-learning model in parallel.

17. The apparatus of claim 15, wherein conflicting labels are resolved based on voting, wherein a label losing the vote is modified in favor of a label that won the vote.

18. The apparatus of claim 15, wherein the first range and second range correspond to a respective percentage range.

19. The apparatus of claim 15, wherein the first range and second range correspond to one or more respective predetermined values that indicate a limit.

20. The apparatus of claim 15, wherein the meta-learning model includes a ProtoBERT model.
